(19) United States
(12) Patent Application Publication
(10) Pub. No.: US 2023/0406291 A1
(43) Pub. Date: Dec. 21, 2023

(54) METHOD FOR CONTROLLING A VEHICLE IN A TRAFFIC SYSTEM

(71) Applicant: Continental Automotive Technologies GmbH, Hannover (DE)

(72) Inventor: Ulrich Stählin, Eschborn (DE)

(73) Assignee: Continental Automotive Technologies GmbH, Hannover (DE)

(21) Appl. No.: 18/335,443

(22) Filed: Jun. 15, 2023

(30) Foreign Application Priority Data
Jun. 15, 2022 (DE) 10 2022 206 068.7

(51) Int. Cl. B60W 30/06; G08G 1/16

(52) U.S. Cl. CPC B60W 30/06; G08G 1/168; B60W 2556/45; G01C 21/3476

(57) ABSTRACT

A method for controlling a vehicle in a parking system including detecting a first vehicle in the parking system, determining the first vehicle as a hazard or obstacle uncontrollable by parking system, calculating a route to park a second vehicle in the parking system that avoids the first vehicle, and controlling to park the second vehicle according to the route

### CROSS-REFERENCE TO RELATED APPLICATIONS

The present application claims or priority from German Patent Application No. 2022 206 068.7 filed on Jun. 15, 2022, the disclosure of which is herein incorporated by reference.

### BACKGROUND

### 1. Field

Aspects of embodiments of the present application relate to a method for controlling a vehicle in a traffic system, in particular a parking system.

### 2. Description of Related Art

Traffic systems for controlling vehicles within a traffic area are known from the prior art. For this purpose, such a traffic system has environment sensors which monitor the entire traffic area and all road users moving in this traffic area. Moreover, such a traffic system has a control unit, which can calculate a route for each of the vehicles moving in the traffic area, and a communication device. The communication device can set up a communication connection to the vehicles, via which communication connection driving instructions can be sent to the vehicles on the basis of which the vehicles can drive along the calculated routes.

The traffic system uses the environment sensors to monitor the vehicles and the movements thereof and can possibly adjust and/or correct the driving instructions depending on the sensor information from the environment sensors. The vehicle does not need its own environment sensor system since the entire vehicle environment is monitored by the environment sensors. If the environment sensors detect a hazard spot or an obstacle for the vehicle, the driving instructions sent to the vehicle are accordingly adjusted. For example, the vehicle can be prompted to swerve or be stopped.

For example, such a traffic system can be a type 2 Automated Valet Parking System. In the case of such a parking system, the vehicle driver hands over a vehicle to the parking system in a hand-over area. The parking system then takes over the control of the vehicle and drives it to a parking space by remote control. Remote control here comprises the taking over of the control of the vehicle. That is to say the traffic system calculates a route for the vehicle and sends corresponding information, for example control commands, to the vehicle so that the vehicle is moved along the route. In addition, the traffic system takes over the monitoring of the vehicle and of the entire traffic area. This comprises checking whether the vehicle is moving along the route but also ensuring that the vehicle cannot collide with other objects, in particular moving objects.

The traffic system usually calculates a route, wherein the calculation of the routes ensures that the vehicles have a sufficient distance between each other.

If a vehicle does not have the capability to be remotely controlled by the traffic system, it is not allowed to enter the traffic system since the movements of this vehicle cannot be controlled by the traffic system. If such a vehicle nevertheless enters the traffic system, the traffic system identifies it as a foreign object or obstacle. The vehicles have to keep as large a safety distance as possible from such foreign objects in order to reliably prevent a collision with the foreign object. As a result, calculating the routes for the vehicles, for which the traffic system can take over control, can become more complex since these vehicles have to avoid the foreign object by a wide margin.

### SUMMARY

Objects of embodiments of the present application provide a method for controlling a vehicle in a traffic system, which method ensures as high a safety as possible and as uninterrupted a flow of traffic as possible, even when vehicles which cannot be remotely controlled are driving.

To achieve the object, there is provision for a method for controlling a vehicle in a traffic system, in particular a parking system, the traffic system having at least one environment sensor for monitoring a traffic area of the traffic system, in particular a parking area of a parking system, a communication system for communicating with the vehicle and a control system for calculating a route for the car. The traffic system is able to take over the control of the vehicle via the communication system and guide the vehicle along the calculated route. The method has the following steps registering the vehicle with the traffic system, using the traffic system to check whether the control of the vehicle is able to be taken over via the communication device, if the traffic system is unable to take over the control of the vehicle, transmitting the calculated route to the driver and the driver guiding the vehicle along the transmitted route.

When the vehicle is being registered, preferably before the vehicle enters the traffic system, it is thus verified whether the traffic system is able to remotely control the vehicle. If the traffic system is able to remotely control the vehicle, the traffic system then takes over the remote control of the vehicle, calculates a route for the vehicle and guides the vehicle along this route over the traffic area.

If no remote control of the vehicle is possible, a route for the vehicle is likewise calculated and the driver is notified of this route so that they can travel the route independently along with a vehicle.

As a result, the journey of a vehicle which cannot be remotely controlled by the traffic system can become more controlled and more predictable, and so the traffic system does not have to regard this vehicle as a foreign body or hazard spot. Since the journey of the vehicle is more predictable, the routes of the other vehicles can be planned better and other safety distances can possibly be taken into account.

Preferably, the vehicle receives a route for which, compared to the routes of the remotely controlled vehicles, additional safety distances and/or safety parameters are taken into account in order to be able to react to abnormal behavior of the driver.

On the whole, transmitting a route for the vehicle which cannot be remotely controlled makes its journey more predictable, as a result of which the safety in the traffic system can be increased.

In principle, the route can be presented in any way perceptible to the driver such that they can drive along this route. In particular, the driver can be notified of the entire route or only individual driving instructions are transmitted.

For example, the route is transmitted in such a way that the route or driving instructions for this route are displayed to the driver within the vehicle.

The route can be transmitted, for example, to a communication unit of the driver and the communication unit notifies the driver of the route. Using a mobile communication unit offers the advantage of the driver being able to be notified of a route independently of the vehicle, in particular independently of the communication capabilities of the vehicle. For example, the communication unit can be vehicle-independent so that the driver can use the communication unit in different vehicles.

The communication unit can be provided exclusively for displaying the route or can be a general communication unit designed for various communication capabilities. For example, there can be provision on the communication unit for a program for displaying the route or driving instructions, wherein this program can be a program specially designed for communication with the traffic system or a general program, for example a navigation program.

The communication unit is preferably a mobile communication unit.

Alternatively, the communication unit can be a vehicle communication unit, that is to say a communication unit installed in the vehicle. This can have the advantage of it being possible for the route to be presented via the communication unit installed in the vehicle. For example, the vehicle has a navigation system and the route is sent to the navigation system which notifies the driver of said route or displays said route to the driver. The driver can thereby access the technology that is known and familiar to them within the vehicle, as a result of which the communication with the driver can be easier and more reliable.

The route can be transmitted to the driver in any way which ensures that the driver can perceive the route or corresponding driving instructions. For example, the route can be transmitted to the driver visually and/or audibly.

Transmitting the route to the communication unit can comprise, for example, the route or individual driving instructions being sent to the communication unit, wherein the communication unit, for example a suitable program on the communication unit, presents the route or the driving instructions in such a way that the driver can follow the route. Alternatively, a web-based presentation can also take place, for example on a homepage which is called up via the communication unit.

The route can be sent from the communication system to the communication unit in various ways. For example, the route is transmitted directly from the communication system to the communication unit, in particular via a local network within the traffic system. The local network can be provided solely in a hand-over or entry area in which the vehicle arrives at the traffic area of the traffic system. However, the local network is preferably receivable over the entire traffic area, in particular in order to remotely control vehicles over the traffic area so that changes to the route and/or hazard warnings can also be transmitted to the communication unit, and therefore to the driver, via the local network.

In particular, a local network offers the advantage of corresponding communication devices, for example transmitting and/or receiving devices within the traffic system, being able to influence the quality of the communication connection between the traffic system and the vehicle.

Alternatively, the route can also be transmitted to the communication unit via a global communication network. For example, a global telecommunications network can be used for transmitting the route.

Optionally, both a local communication network and a global communication network can also be used, wherein the choice of the communication network can be made depending on the quality of the communication connection between the vehicle and the traffic system.

In the embodiment described above, the presentation of the route or the transmission of the route or of the driving instructions to the driver takes place in each case inside the vehicle.

Optionally, the route can also be presented by at least one communication device provided in the traffic system, that is to say can be presented outside of the vehicle. As a result, the route can be presented regardless of the communication capabilities present in the vehicle. In particular, it is not required for a communication unit to be present and/or to be used in the vehicle.

Moreover, presenting the route or the driving instructions by way of the traffic system can have the advantage of other road users within the traffic system likewise being able to perceive these instructions, and thus the driving behavior of the vehicle is more predictable for other road users.

The route or the driving instructions can be presented visually or audibly. For example, the route or a driving instruction can be characterized or presented by corresponding light signals within the traffic system so that the driver can easily follow this route or driving instruction. Optionally, there can also be provision for other signals which display the driving direction to the driver or warn the driver about hazard spots.

To carry out the method described above, it is necessary for the driver to register themselves and their vehicle before entering the traffic system in order to check whether the vehicle is able to be remotely controlled by the traffic system. Registering with the traffic system can be done in various ways.

For example, the vehicle or the driver can be registered with the traffic system via a communication unit of the driver. For example, registering can be done via a homepage or via a program installed on the communication unit. The program, or the application via which registration takes place, can also be used later, for example, for the notification of the driving instructions or of the route.

Registering can be done, for example, via a local communication network and the communication system of the traffic system. As a result, the vehicle or the communication unit located in the vehicle can be uniquely assigned.

Optionally, registering can also be done via a global communication network. In particular, as a result, it is possible to verify whether the traffic system is able to remotely control the vehicle already before the latter enters the traffic system.

In particular, registering involves uniquely identifying the vehicle. This is required in order for it to be possible to uniquely assign the vehicle and the route thereof while the vehicle drives in the traffic system.

The vehicle can be identified in various ways, for example by locating the communication unit within the vehicle. Furthermore, vehicle parameters which allow the vehicle to be uniquely identified can be specified during the registration. In addition, the driver can be prompted to uniquely identify the vehicle before entering the traffic system, for example by specifying actions to be performed by the driver, for example giving particular light signals.

Registering can also be done for example at registration points or registration areas provided for the registration, as a result of which assignment or identification of the vehicles can be simplified, in particular if only one vehicle is located in a registration area or at a registration point at a time.

### BRIEF DESCRIPTION OF THE DRAWINGS

Further advantages and features will become apparent from the following description in connection with the appended drawings. In the drawings:

FIG. 1 shows a schematic representation of a traffic system;

FIG. 2 shows a schematic representation of a vehicle driving in the traffic system from FIG. 1;

FIG. 3 shows a schematic representation of a second vehicle driving in the traffic system from FIG. 1; and

FIG. 4 shows a flowchart of a method for controlling a vehicle in the traffic system from FIG. 1.

### DETAILED DESCRIPTION

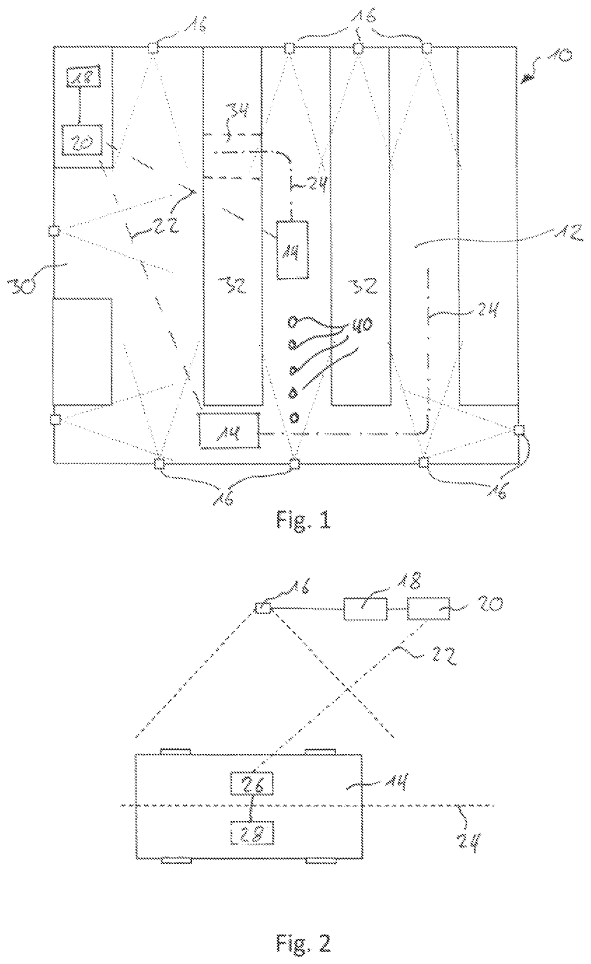

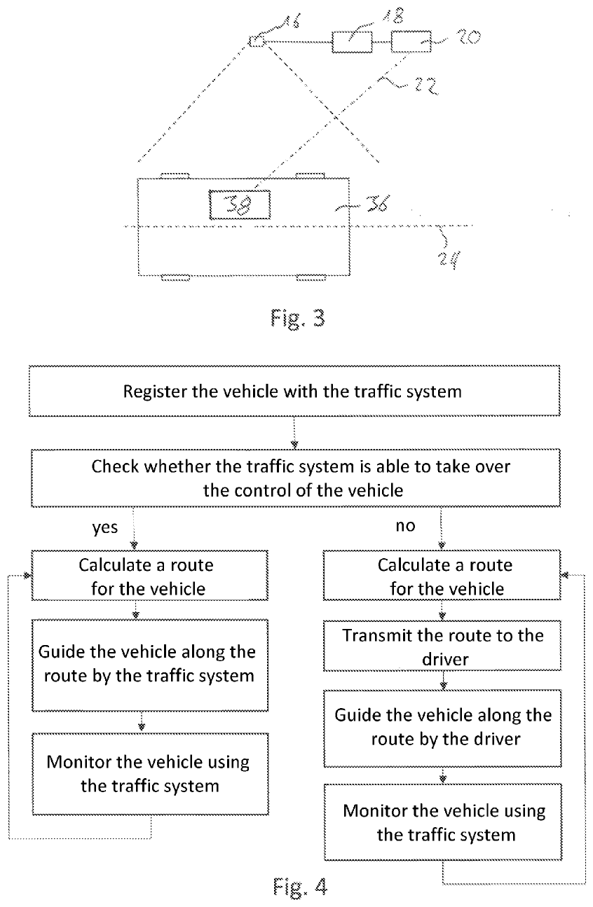

FIG. 1 shows a traffic system 10. The traffic system 10 has a traffic area 12 over which vehicles 14 can move, and a plurality of environment sensors 16 which can cover the entire traffic area 12 and detect the vehicles 14 and road users moving in the traffic area 12. Moreover, the traffic system 10 has a control unit 18 and a communication system 20 for setting up a communication connection 22 to the vehicles 14.

Based on the information recorded by the environment sensors 16 about the traffic area 12 and the vehicles 14 moving therein, the control unit 18 can calculate a route 24 within the traffic area 12 for each of the vehicles 14 and determine corresponding driving instructions or control commands for the vehicles 14. These driving instructions or control commands can be sent to the vehicles 14 via the communication connection 22.

The vehicles 14 each have a communication unit 26 for setting up the communication connection 22 to the communication device 20. The vehicles 14 can receive the control commands via the communication unit 26 or the communication connection 22 and forward them to a vehicle control system 28. The vehicle control system 28 can implement the control commands so that the vehicles 14 are moved through the traffic area 12 by the traffic system 10.

In the embodiment described here, the traffic system 10 is a parking system which has a registration area 30 and a parking area 32 in which the vehicles 14 can be parked.

In the registration area 30, a vehicle user can hand over their vehicle 14 to the traffic system 10 or register with the traffic system 10. The parking system then establishes a communication connection 22 with the vehicle 14 and sends the control commands in order to steer the vehicle to a parking space 34 in the parking area 32 by remote control.

If the vehicle user wishes to use his vehicle 14, a communication connection 22 to the vehicle 14 is once again set up and the vehicle 14 is driven by way of corresponding control commands to the registration area 30 where the vehicle user can pick up their vehicle 14.

The traffic system 10 uses the environment sensors 16 to monitor the vehicles 14 within the traffic area 12 and can correct the control commands or driving instructions for the vehicles 14 on the basis of the information from the environment sensors 16.

The traffic system 10 here completely takes over the control of the vehicles 14 within the traffic area 12. The control of the vehicle 14 comprises sending driving instructions and/or control commands which are implemented by the vehicle, in particular in an automated or semi-automated manner, and monitoring the vehicle 14 and the movements thereof within the traffic area 12. That is to say the traffic system 10 also records the environment of the vehicles 14 and sends corresponding control commands to swerve or stop a vehicle 14 if hazard spots or obstacles for the vehicle or other road users within the traffic area 12 are present.

The method described above presupposes that the vehicles 14 are designed to be remotely controlled by the traffic system 10, i.e. the vehicles require a communication device 20 and a vehicle control system 28 which can implement the control commands from the traffic system 10.

If a vehicle 36 which is not able to be remotely controlled by the traffic system is located in the traffic area, this vehicle is detected as an obstacle or hazard spot. The routes of the other vehicles 14 are planned or corrected accordingly so that the vehicles 14 can keep a defined safety distance from this vehicle 36.

In order to improve the traffic flow or the flows within the traffic system 10, such vehicles 36 can also register with the traffic system 10. In particular, registering can be done in the registration area 30 such that registration with the traffic system is mandatorily required before the vehicle 36 arrives at the traffic area 12.

Registering can be done in various ways here. For example, the registration area 30 can be provided with registration apparatuses at which the driver registers themselves and their vehicle. Alternatively, registering can be done via a communication unit 38, for example a mobile communication unit, in particular a telecommunication unit. For example, the driver can use the communication unit 38 to dial into a local communication network of the traffic system 10 and register the vehicle. Optionally, registering can be done via a global communication network, for example a telecommunications network.

For example, there can be provision on the communication unit 38 for a program for registering with the traffic system 10, wherein vehicle information and/or information about the driver can be stored in this program. Alternatively, registering can be done via a web-based platform, for example a homepage.

Furthermore, the vehicle 36 is uniquely identified during or immediately after the registration in order to be able to uniquely assign the route 24 or driving instructions to this vehicle 36. For example, this identification takes place in the registration area 30. In particular, the traffic system 10 can be correspondingly set up to ensure that only one vehicle 36 is located in the registration area 30 at a time during the registration so that it is made clear which vehicle 36 is being registered with the traffic system 10.

Optionally, the vehicle 36 can be identified by the location of the communication unit 38 or the driver is prompted to identify the vehicle by performing a defined action, for example by actuating an illumination device or by driving along a particular section of the traffic area 12.

If the vehicle 36 leaves the traffic area 12 or the traffic system 10, deregistration is preferably carried out by the driver.

During or after the registration of the vehicle with the traffic system 10 by the driver, the traffic system 10 checks whether the control of the vehicle and therefore remote control of the vehicle 36 is able to be taken over via the communication system 20.

If it is possible for the traffic system 10 to take over the control of the vehicle, the driver can leave their vehicle and the vehicle 14 is remotely controlled within the traffic system 10 or over the traffic area 12 via the communication connection.

If the check by the traffic system 10 shows that the traffic system 10 is unable to take over the vehicle control of the vehicle 36, the driver has to guide the vehicle 36 within the traffic system 10. For this purpose, the traffic system 10 calculates a route 24 for the vehicle 36 and transmits it to the driver so that the driver can travel the route 24 independently.

Transmitting the route 24 to the driver means that the movements of the vehicle with respect to 30 are predictable such that the routes 24 of the other vehicles 14 are able to be planned better.

The route 24 can be transmitted to the driver in various ways.

For example, the route 24 is transmitted to the communication unit 38 of the driver and the latter notifies the driver visually or audibly. For example, the communication unit 38 outputs driving instructions which are based on the transmitted route. In particular, the route 24 can be presented visually, for example on a map.

The communication unit 38 here can also be a communication unit installed in the vehicle 36, for example a navigation unit to which the traffic system 10 transmits the route 24 so that the navigation unit can present this route on a screen.

In addition, the traffic system 10 can be provided with communication devices via which the route can be presented to the driver visually, audibly or in another way. For example, the communication devices 40 have illumination elements which notify the driver of the route and/or driving instructions. For example, the route can be visually presented by illumination elements embedded in the traffic area so that the driver can easily carry out the route.

Independently of the exemplary embodiments described above, the driver can be notified of the route in any way that ensures that the driver can reliably perceive the route and/or driving instructions. In particular, notification of the route and/or driving instructions can be given regardless of communication units or vehicle-connected devices.

1. A method of controlling a vehicle in a parking system, the method comprising:
detecting a first vehicle in the parking system;
determining the first vehicle as a hazard or obstacle uncontrollable by parking system;
calculating a route to park a second vehicle in the parking system that avoids the first vehicle; and
controlling to park the second vehicle according to the route.

2. The method as claimed in claim 1, further comprising transmitting the route to the second vehicle.

3. The method as claimed in claim 2, further comprising:
determining a second route to park the first vehicle in the parking system; and
transmitting the second route to the first vehicle.
